(19) United States
(12) Patent Application Publication
(10) Pub. No.: US 2025/0019248 A1
(43) Pub. Date: Jan. 16, 2025

(54) Method for preparing nanometer silicon powder by induction plasma pyrolysis of silane

(71) Applicant: China Nonferrous Metal (Guilin) Geology And Mining Co.,Ltd., Guilin (CN)

(72) Inventors: Haiqing Qin, Guilin (CN); Zhenjun Zhang, Guilin (CN); Huijie Tang, Guilin (CN); Wenping Liu, Guilin (CN); Xiaoxu Lei, Guilin (CN); Anjun Lu, Guilin (CN); Leyin Xiao, Guilin (CN)

(73) Assignee: China Nonferrous Metal (Guilin) Geology And Mining Co.,Ltd., Guilin, GX (CN)

(21) Appl. No.: 17/927,014

(22) PCT Filed: Apr. 16, 2022
(86) PCT No.: PCT/CN2022/087241

§ 371 Date: Oct. 3, 2024

(30) Foreign Application Priority Data
Dec. 22, 2021 (CN) 202111579320.3

(51) Int. Cl. C01B 33/029; B82Y 30/00; B82Y 40/00

(52) U.S. Cl. CPC C01B 33/029; B82Y 30/00; B82Y 40/00; C01P 2004/03; C01P 2004/32; C01P 2004/64

(57) ABSTRACT

The present invention discloses a method for preparing nanometer silicon powder by induction plasma pyrolysis of silane, which comprises the following steps: exciting working gas in an induction plasma reactor to form stable high-temperature plasma; mixing gaseous silane with dilution gas; injecting into a high-temperature plasma thermal field; decomposing the gaseous silane under a joint action of a hot airflow and a high-temperature circulating cooling airflow in the high-temperature plasma thermal field; cooling and condensing silicon atoms generated by pyrolysis into nanometer-scale spherical silicon powder; filtering an airflow wrapped with the silicon powder by filters; depositing the nanometer silicon powder on the surfaces of the filters; then blowing off the nanometer silicon powder by a periodic back blowing airflow; and collecting the nanometer silicon powder. The present invention uses silane gas as a raw material, induction plasma as a main heat source and an ordinary heating pipe as an auxiliary heat source, and has the advantages of high thermal decomposition rate, no electrode pollution and long-term continuous production. The prepared nanometer silicon powder has high purity, high sphericity, narrow particle size distribution, good fluidity and high quality.

### TECHNICAL FIELD

The present invention relates to the technical field of material chemistry, in particular to a method for preparing nanometer silicon powder by induction plasma pyrolysis of silane.

### BACKGROUND

With the rise of new energy-related industries and the popularity of 3C electronic products, people have put forward higher requirements for lithium-ion batteries, namely higher volume/mass ratio energy density, faster charging and discharging rates and higher safety. Silicon material, with its energy density about 10 times that of graphite, has become a strong competitor of negative electrode materials for lithium ion batteries. However, when silicon is used as a negative electrode material, it has a very serious defect. After lithium embedding, silicon will expand to about three times the original volume, which restricts the application in this field. Nanometer silicon powder can effectively reduce this negative effect because of its nanometer effect. The surface of the nanometer silicon powder is coated with carbon and used with graphite, which can effectively improve the capacity and effective service life of a lithium ion battery, and control an expansion rate of negative electrode materials within an acceptable range. In addition, the nanometer silicon powder has a wide application prospect in other fields. For example, the nanometer silicon powder and diamond are mixed at high pressure to form silicon carbide which is often used as an abrasive, a grinding tool and a cutting tool; and the nanometer silicon powder can react with an organic matter to serve as a raw material of organosilicon polymer materials.

At present, methods for preparing the nanometer silicon powder include the mechanical ball milling method, the chemical vapor deposition method, the molten salt electrolysis method, and the plasma evaporation and condensation method. Generally, the mechanical ball milling method uses zirconia as a grinding medium, and grinds silicon particles with a large particle size into silicon powder with a small size, with the advantages of simple steps and relatively low cost. However, an impurity content of the obtained silicon powder is high; the particle morphology and particle size range are difficult to control; and it is difficult to obtain nano-scale products. The chemical vapor deposition method is to heat silane in an atmosphere of high purity hydrogen dilution until the silane is decomposed, and then to cool the decomposed product to obtain the nanometer silicon powder. However, high-pressure and high-concentration hydrogen and silane are involved in the preparation process; and there are large potential safety hazards. The size of silicon particles prepared by electrolysis of SiO₂ with anhydrous CaCl₂) as an electrolyte in the molten salt electrolysis method is uneven; and it is difficult to control the further growth of silicon particles. The plasma evaporation and condensation method usually uses micron-scale silicon powder as a raw material, uses DC arc plasma as a heat source to vaporize a silicon raw material instantly, and then cools silicon steam to prepare the nanometer silicon powder. In the preparation process, it is easy to introduce pollution caused by electrode material vaporization; and thermal coupling efficiency between the micron-scale raw material powder and plasma is low, which makes it difficult to guarantee the purity and the yield of products.

Therefore, it is an urgent technical problem for those skilled in the art to provide a method for preparing the nanometer silicon powder by induction plasma pyrolysis of silane with high silane decomposition rate, strong safety and continuous production.

### SUMMARY

In view of this, the present invention provides a method for preparing nanometer silicon powder by induction plasma pyrolysis of silane.

In order to achieve the above purpose, the present invention adopts the following technical solution:

A method for preparing nanometer silicon powder by induction plasma pyrolysis of silane comprises the following steps: exciting working gas in an induction plasma reactor to form stable high-temperature plasma; mixing gaseous silane with dilution gas; injecting into a high-temperature plasma thermal field; decomposing the gaseous silane under a joint action of a hot airflow and a high-temperature circulating cooling airflow in the high-temperature plasma thermal field; cooling and condensing silicon atoms or silicon ions generated by pyrolysis into nanometer-scale spherical silicon powder; filtering an airflow wrapped with the silicon powder by filters after the airflow enters a collection chamber including the filters; depositing the nanometer silicon powder on the surfaces of the filters; then blowing off the nanometer silicon powder by a periodic back blowing airflow; and collecting the nanometer silicon powder.

Further, the method specifically comprises the following steps:
(1) flushing a whole pyrolysis system with argon or nitrogen and carrying out leakage detection;
(2) introducing the working gas into the plasma reactor; exciting to form the stable high-temperature plasma with predetermined power; introducing the high-temperature circulating cooling airflow into a first-stage high-temperature cooling area by a compressor; and introducing a low-temperature circulating cooling airflow and a nitrogen cooling airflow into a second-stage low-temperature cooling area;
(3) injecting the gaseous silane into the high-temperature plasma thermal field wrapped by a dilution airflow by using a feeding probe; decomposing silane in the high-temperature plasma thermal field; then in the first-stage high-temperature cooling area, cooling silicon atoms or silicon ions generated by pyrolysis to form tiny silicon powder; meanwhile, further pyrolyzing the undecomposed silane gas to generate silicon powder and hydrogen; and carrying the silicon powder to the second-stage low-temperature cooling area by the mixed airflow for further cooling; and
(4) carrying the silicon powder cooled by the second-stage low-temperature cooling area to the collection chamber by the mixed airflow; after the gas passes the filters of the collection chamber, exhausting part of the gas after being treated; using the remaining gas as circulating cooling gas for circulation; and blocking the nanometer silicon powder by the filters and adhering to the surfaces of the filters; blowing off the nanometer silicon powder by the periodic back blowing airflow; and collecting the nanometer silicon powder.

Further, the working gas includes center gas and sheath gas.

Further, the center gas is argon with a flow rate of 5-100 slpm; the sheath gas is mixed gas of argon and hydrogen; the flow rate of argon in the sheath gas is 20-250 slpm; and the flow rate of hydrogen in the sheath gas is 0-30 slpm.

The above further solution has the beneficial effects that: introduction of a proper amount of hydrogen into the sheath gas can effectively improve thermal conductivity of the plasma hot airflow, and further improve heating efficiency of the plasma thermal field.

Further, the power of the plasma reactor in step (2) is 15-80 kw; and the working pressure of the system is 14-17 Psig.

The above further solution has the beneficial effects that: setting the working pressure of the system to be about equal to one atmosphere can reduce an air tightness requirement of the system, and also reduce possibility of causing fire and explosion dangers when the system has serious leakage.

Further, the high-temperature circulating cooling airflow is mixed gas of nitrogen, argon and hydrogen; the temperature of the high-temperature circulating cooling airflow is 420-650° C.; and the flow rate is 1000-3000 slpm.

Further, the volume ratio of nitrogen, argon and hydrogen in the mixed gas of the high-temperature circulating cooling airflow is: 50% of nitrogen, 40% of argon and 10% of hydrogen.

Further, the low-temperature circulating cooling airflow is mixed gas of nitrogen, argon and hydrogen; the temperature of the low-temperature circulating cooling airflow is 18-35° C.; the flow rate is 5000-15000 slpm; and the flow rate of the nitrogen cooling airflow is 150-450 slpm.

Further, the volume ratio of nitrogen, argon and hydrogen in the mixed gas of the low-temperature circulating cooling airflow is: 50% of nitrogen, 40% of argon and 10% of hydrogen.

The above further solution has the beneficial effects that: nitrogen with a relatively low price is used as the main cooling gas, which can effectively reduce the preparation cost; and meanwhile, nitrogen has a high specific heat capacity, which can effectively improve cooling efficiency. The circulating cooling airflow with relatively high temperature (higher than the pyrolysis temperature of silane gas) is used for first-stage cooling, and can be used as an auxiliary heat source to provide energy and a reaction atmosphere for a small amount of unreacted silane gas while cooling silicon atoms or silicon ions to generate silicon particles, thereby greatly increasing the thermal decomposition rate of silane gas (more than 99%). The low-temperature circulating gas with an ultra-large flow rate is used for second-stage cooling, which can effectively control the further growth of silicon particles generated by the reaction, and can serve as a main cooling means to control the gas temperature in the system within a lower range, to effectively avoid interference of powder in the cooling process and achieve the purpose of long-term stable operation.

Further, the airflow rate of the gaseous silane is 15-120 slpm; and the dilution airflow is argon with a flow rate of 50-200 slpm.

The above further solution has the beneficial effects that: the silane is used as the raw material gas, which can realize molecular contact between the raw material and the plasma thermal field and improve the thermal coupling efficiency; and meanwhile, generation of micron-scaled large particles caused by incomplete vaporization of crude silicon powder can be avoided when the crude silicon powder is used as a raw material for production. Introduction of the dilution airflow can restrict the flow direction of silane gas and prevent the silane gas from escaping before being injected into the high-temperature thermal field; and meanwhile, the dilution airflow can dilute the silane gas preliminarily before injection, which is helpful to generate a nanometer silicon powder product with a smaller particle size.

Further, the back blowing gas is argon or nitrogen.

The above further solution has the beneficial effects that: argon or nitrogen can be used as the back blowing gas to complete the back blowing step without introducing more kinds of gases, thereby reducing complexity of process conditions.

The present invention has the beneficial effects that: the present invention uses the silane gas as the raw material, the induction plasma as a main heat source, and an ordinary electric heating pipe as an auxiliary heat source; and the nanometer silicon powder is prepared by multistage reaction and multistage cooling. The method has the advantages of high silane decomposition rate, strong safety and continuous production.

According to the present invention, the induction plasma is used as the main heat source, so that the raw material gas can be heated centrally under the condition of zero contact between materials and equipment; electrode pollution will not be introduced; product purity can be improved; and the method can prevent the powder generated by the reaction from sticking on the surface of the heating device in the heating process, improve the heating efficiency, reduce equipment maintenance cost, and facilitate industrial continuous production.

According to the present invention, the silane gas is used as the raw material, so that the molecular contact between the raw material and the plasma hot airflow can be realized; the thermal coupling efficiency is greatly improved; and the energy utilization rate is improved. Meanwhile, the use of the silane gas as the raw material can avoid generation of the micron-scaled large particles caused by incomplete vaporization of crude silicon powder when the crude silicon powder is used as the raw material for production, which is conducive to improving quality of the nanometer silicon powder products in terms of particle size.

According to the present invention, the ordinary electric heating pipe is used as the auxiliary heat source and combined with the induction plasma heat source; and the multistage reaction and multistage cooling modes are innovatively introduced, so that the advantages of the two heating modes are fully exerted; and the pyrolysis rate of silane gas is greatly improved. By adopting the method of the present invention, the pyrolysis rate of silane can reach more than 99%, which can effectively improve the utilization rate of silane gas and reduce environmental protection cost of tail gas treatment, thereby achieving the purpose of reducing production cost.

In the preparation process of the present invention, about 90% of the working gas is recycled and used as the cooling airflow with the ultra-large flow rate, which can not only effectively control the particle size of nanoparticles, but also reduce the use amount of working gas and save the cost. Meanwhile, the working gas with the relatively large flow rate can dilute the total concentration of hydrogen and silane in the system to lower than 10%, which greatly reduces the possibility of the danger of system leakage in extreme cases.

According to the present invention, the feeding probe with a double-layer coaxial pipe structure is used for feeding; and the silane gas wrapped by an argon curtain is directly injected into the high-temperature plasma thermal field, so that the silane gas can be prevented from escaping before entering the plasma thermal field; and argon can be used for preliminary dilution of the silane gas, which is conducive to improving the heating efficiency and reducing the particle size of the nanometer silicon powder.

According to the present invention, a long cylindrical filter set made of porous cermet is used for gas-solid separation; and the filters are blown back one by one by the periodic back blowing airflow, so that higher filtration efficiency and longer use period than the traditional cloth bag collector can be achieved; and long-term continuous production can be realized.

The average particle size of the nanometer silicon powder prepared by the present invention is adjustable from 30 nm to 120 nm; and the nanometer silicon powder has the characteristics of high purity, narrow distribution, spherical shape, easy dispersion, good fluidity, large specific surface area and high surface activity.

The present invention further provides a device for preparing nanometer silicon powder by induction plasma pyrolysis of silane, which comprises a plasma generator, feeding probes, a first-stage high-temperature cooling area, a second-stage low-temperature cooling area, a collection chamber, filters, a compressor, an electric heating pipe, a water-cooling heat exchanger and a tail gas treatment device.

Specifically, the plasma generator and the feeding probes are fixed in the first-stage high-temperature cooling area; the second-stage low-temperature cooling area is fixed at the bottom of the first-stage high-temperature cooling area; the bottom end of the second-stage low-temperature cooling area is communicated with one side of the collection chamber; the other side of the collection chamber is communicated with the water-cooling heat exchanger; the compressor is arranged between the collection chamber and the water-cooling heat exchanger; the electric heating pipe is arranged between the compressor and the water-cooling heat exchanger; and the tail gas treatment device is arranged between the compressor and the collection chamber.

The surface of the first-stage high-temperature cooling area is provided with a high-temperature circulating cooling airflow inlet; the second-stage low-temperature cooling area is provided with a low-temperature circulating cooling airflow inlet; and the low-temperature circulating cooling airflow inlet is further provided with a nitrogen cooling airflow inlet.

The bottom end of the collection chamber is provided with a powder collecting tank; and the filters are arranged in the collection chamber.

Further, a feeding probe structure is a double-layer coaxial pipe; an inner pipe is a silane gas channel; and an interlayer between the inner pipe and an outer pipe is a dilution gas channel. Three to four feeding probes are arranged.

Further, 10-30 filters are arranged in the collection chamber; the filters are made of porous cermet; and the shape of the filters is a long cylindrical shape.

### BRIEF DESCRIPTION OF DRAWINGS

FIG. 1 is a schematic diagram of a device structure and a method flow for preparing nanometer silicon powder by induction plasma pyrolysis of silane according to the present invention;
referential numbers in the figure: 1—induction plasma generator, 2—center gas, 3—sheath gas, 4—feeding probe, 5—silane airflow, 6—dilution airflow, 7—first-stage high-temperature cooling area, 8—second-stage low-temperature cooling area, 9—high-temperature circulating cooling airflow inlet, 10—low-temperature circulating cooling airflow inlet, 11—nitrogen cooling airflow inlet, 12—collection chamber, 13—filter, 14—powder collecting tank, 15—compressor, 16—electric heating pipe, 17—water-cooling heat exchanger, and 18—tail gas treatment device;

FIG. 2 is an electron microscope diagram of a nanometer silicon powder sample prepared in embodiment 1 of the present invention; and

FIG. 3 is an electron microscope diagram of a nanometer silicon powder sample prepared in embodiment 2 of the present invention.

### DETAILED DESCRIPTION OF THE EMBODIMENTS

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

The purity of silane, hydrogen, argon and nitrogen used in the embodiments of the present invention is 99.9999%, 99.999%, 99.999% and more than 99.99% respectively.

### Embodiment 1

1) Preparation process: the system is flushed for 10 min by using argon with a flow rate of 300 slpm, and leak detection is conducted. The leak detection process comprises high-pressure leak detection and low-pressure leak detection. The standards are as follows: when the system is at a high pressure of 18 psi, the leakage rate is not higher than 5 slpm; and when the system is at a low pressure of 2 psi, the leakage rate is not higher than 2 slpm. 30 slpm of center gas (argon) and sheath gas (mixed gas of 90 slpm of argon and 10 slpm of hydrogen) is introduced into the induction plasma generator. The induction plasma is excited; the system pressure is adjusted to 14.5 psi; and the power of the induction plasma generator is adjusted to 40 kw. Then, the compressor is started; the high-temperature circulating cooling airflow of 1500 slpm and 430° C. is introduced into the first-stage high-temperature cooling area; and the low-temperature circulating cooling airflow of 6500 slpm and 28° C. and the nitrogen cooling airflow of 250 slpm are introduced into the second-stage low-temperature cooling area.
2) Reaction process: a total of 30 slpm of silane airflow is introduced into the inner pipes of 3 feeding probes, and 90 slpm of argon is introduced into the interlayer between the inner and outer pipes as a dilution airflow. The silane gas is wrapped and diluted by argon and directly injected into the hot plasma airflow with the core temperature as high as 10,000° C., and rapidly decomposed into atomic or ionic silicon and hydrogen. When passing through the first-stage high-temperature cooling area, the silicon atoms or ions are rapidly cooled to form tiny silicon particles. Meanwhile, a small amount of undecomposed silane gas is further pyrolyzed in the area to generate tiny silicon particles and hydrogen. Then, the mixed airflow carries the silicon powder into the second-stage low-temperature cooling area; and the temperature of the gas and silicon powder is suddenly reduced to be lower than 200° C. after cooling.
3) Collection process: the silicon powder generated in the reaction area is carried to the collection chamber by the airflow, wherein after the gas passes through the plurality of filters suspended in the collection chamber, part of the gas is incinerated and washed by the tail gas treatment device and then exhausted; the remaining gas is pressurized by the compressor and recycled; one part is heated by the electric heating pipe and then introduced into the first-stage high-temperature cooling area, while the other part is cooled by the water-cooling heat exchanger and then introduced into the second-stage low-temperature cooling area. The nanometer silicon powder is blocked by the filters and adhered to the surfaces of the filters. Argon is used as the back blowing airflow; the filters are periodically back blown one by one; and the adhered nanometer silicon powder is blown down into the powder collecting tank at the bottom of the collection chamber. The reaction process lasts for 8 hours and 15.8 kg of nanometer silicon powder is obtained by changing the powder collecting tank online and collecting after shutdown.

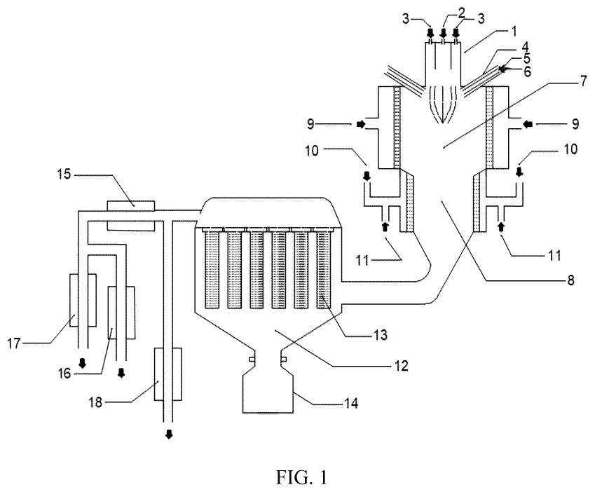

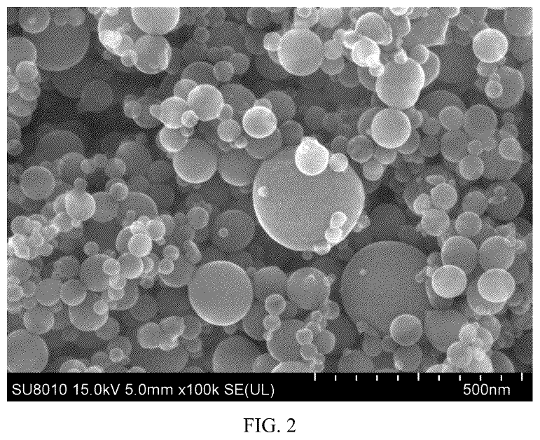

The nanometer silicon powder obtained in the present embodiment is light yellow powder; the BET average particle size is 61 nm; and the particle morphology is spherical or nearly spherical, as shown in FIG. 2.

### Embodiment 2

Embodiment 1 is repeated, with differences as follows:

In step 1), 40 slpm of center gas (argon) and sheath gas (mixed gas of 120 slpm of argon and 15 slpm of hydrogen) is introduced into the induction plasma generator. The induction plasma is excited; the system pressure is adjusted to 14.7 psi; and the power of the induction plasma generator 1 is adjusted to 60 kw. Then, the compressor is started; the high-temperature circulating cooling airflow of 1700 slpm and 450° C. is introduced into the first-stage high-temperature cooling area; and the low-temperature circulating cooling airflow of 7500 slpm and 30° C. and the nitrogen cooling airflow of 300 slpm are introduced into the second-stage low-temperature cooling area.

In step 2), a total of 60 slpm of silane airflow is introduced into the inner pipes of 3 feeding probes, and 150 slpm of argon is introduced into the interlayer between the inner and outer pipes as a dilution airflow.

In step 3), the reaction process lasts for 24 hours and 86.2 kg of nanometer silicon powder is obtained by changing the powder collecting tank 14 online and collecting after shutdown.

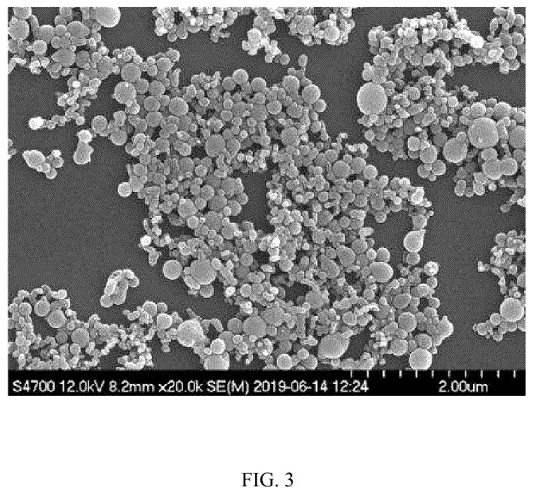

The nanometer silicon powder obtained in the present embodiment is dark yellow powder; the BET average particle size is 98 nm; and the particle morphology is spherical or nearly spherical, as shown in FIG. 3.

Although the embodiments of the present invention have been shown and described above, it will be appreciated that the above embodiments are exemplary and shall not be understood as limitations to the present invention. Those ordinary skilled in the art can make changes, amendments, replacements and variations to the above embodiments within the scope of the present invention.

What is claimed is:

1. A method for preparing nanometer silicon powder by induction plasma pyrolysis of silane, comprising the following steps: exciting working gas in an induction plasma reactor to form stable high-temperature plasma; mixing gaseous silane with dilution gas; injecting into a high-temperature plasma thermal field; decomposing the gaseous silane under a joint action of a hot airflow and a high-temperature circulating cooling airflow in the high-temperature plasma thermal field; cooling and condensing silicon atoms or silicon ions generated by pyrolysis into nanometer-scale spherical silicon powder; filtering an airflow wrapped with the silicon powder by filters after the airflow enters a collection chamber comprising the filters; depositing the nanometer silicon powder on the surfaces of the filters; then blowing off the nanometer silicon powder by a periodic back blowing airflow; and collecting the nanometer silicon powder.

2. The method for preparing nanometer silicon powder by induction plasma pyrolysis of silane according to claim 1, specifically comprising the following steps:
S1 flushing a whole pyrolysis system with argon or nitrogen and carrying out leakage detection;
S2 introducing the working gas into the plasma reactor; exciting to form the stable high-temperature plasma with predetermined power; introducing the high-temperature circulating cooling airflow into a first-stage high-temperature cooling area by a compressor; and introducing a low-temperature circulating cooling airflow and a nitrogen cooling airflow into a second-stage low-temperature cooling area;
S3 injecting the gaseous silane into the high-temperature plasma thermal field wrapped by a dilution airflow by using a feeding probe; decomposing silane in the high-temperature plasma thermal field; then in the first-stage high-temperature cooling area, cooling silicon atoms or silicon ions generated by pyrolysis to form tiny silicon powder; meanwhile, further pyrolyzing the undecomposed silane gas to generate silicon powder and hydrogen; and carrying the silicon powder to the second-stage low-temperature cooling area by the mixed airflow for further cooling; and
S4 carrying the silicon powder cooled by the second-stage low-temperature cooling area to the collection chamber by the mixed airflow; after the gas passes the filters of the collection chamber, blocking the nanometer silicon powder by the filters and adhering to the surfaces of the filters; blowing off the nanometer silicon powder by the periodic back blowing airflow; and collecting the nanometer silicon powder.

3. The method for preparing nanometer silicon powder by induction plasma pyrolysis of silane according to claim 2, wherein the working gas comprises center gas and sheath gas.

4. The method for preparing nanometer silicon powder by induction plasma pyrolysis of silane according to claim 3, wherein the center gas is argon with a flow rate of 5-100 slpm; the sheath gas is mixed gas of argon and hydrogen; the flow rate of argon in the sheath gas is 20-250 slpm; and the flow rate of hydrogen in the sheath gas is 0-30 slpm.

5. The method for preparing nanometer silicon powder by induction plasma pyrolysis of silane according to claim 2, wherein the power of the plasma reactor in step (2) is 15-80 kw; and the working pressure of the system is 14-17 Psig.

6. The method for preparing nanometer silicon powder by induction plasma pyrolysis of silane according to claim 2, wherein the high-temperature circulating cooling airflow is mixed gas of nitrogen, argon and hydrogen; the temperature of the high-temperature circulating cooling airflow is 420-650° C.; and the flow rate is 1000-3000 slpm.

7. The method for preparing nanometer silicon powder by induction plasma pyrolysis of silane according to claim 2, wherein the low-temperature circulating cooling airflow is mixed gas of nitrogen, argon and hydrogen; the temperature of the low-temperature circulating cooling airflow is 18-35° C.; the flow rate is 5000-15000 slpm; and the flow rate of the nitrogen cooling airflow is 150-450 slpm.

8. The method for preparing nanometer silicon powder by induction plasma pyrolysis of silane according to claim 2, wherein the airflow rate of the gaseous silane is 15-120 slpm; and the dilution airflow is argon with a flow rate of 50-200 slpm.

9. The method for preparing nanometer silicon powder by induction plasma pyrolysis of silane according to claim 2, wherein the back blowing gas is argon or nitrogen.
